(19) United States
(12) Patent Application Publication
(10) Pub. No.: US 2011/0008700 A1
(43) Pub. Date: Jan. 13, 2011

(54) FLUID DIVERTER FOR A FUEL CELL SYSTEM

(75) Inventors: Pinakin Patel, Danbury, CT (US); Fred Jahnke, Rye, NY (US); Matt Lambrech, Sherman, CT (US)

Correspondence Address: MICHAUD-Kinney Group LLP, 306 INDUSTRIAL PARK ROAD, SUITE 206, MIDDLETOWN, CT, 06457, US

(73) Assignee: FUELCELL ENERGY, INC., Danbury, CT (US)

(21) Appl. No.: 12/499,129

(22) Filed: Jul. 8, 2009

(51) Int. Cl. H01M 2/08; H01M 2/02

(52) U.S. Cl. 429/455; 429/470

(57) ABSTRACT

A fuel cell module including a fuel cell stack which includes a cathode compartment having cathode conduit extending from an inlet thereof. The cathode conduit conveys a fluid to at least one cathode positioned in the cathode compartment. An anode compartment having a fuel inlet conduit extending from an inlet of the anode compartment, supplies fuel to at least one anode positioned in the anode compartment. An anode exhaust conduit extends from an outlet of the anode compartment, for conveying an anode exhaust fluid. The fuel cell stack is positioned in an enclosure which as has a passage extending therethrough. At least a portion of the passage is in fluid communication with the anode exhaust conduit. The fuel cell module includes a diverter device having at least a portion thereof positioned in the passage and/or the anode exhaust conduit.

### FIELD OF THE INVENTION

The present invention generally relates to a fluid diverter for use in fuel cell systems and more specifically relates to an adjustable diverter capable of directing the flow of fluids within the fuel cell system or directing fluids to and from the fuel cell system.

### BACKGROUND OF THE INVENTION

A fuel cell is a device which uses an electrochemical reaction to convert chemical energy stored in a fuel such as hydrogen or methane into electrical energy. In general, fuel cells include an anode to catalytically react with the fuel and a cathode in fluid communication with an oxidant such as air. The anode and cathode are disposed on opposing sides of an electrolyte material which conducts electrically charged ions therebetween. The electrolyte material and the design of the fuel cell determine the type and performance of the fuel cell. For example, Molten Carbonate Fuel Cells (MCFC) which operate at approximately 650° C. typically include an electrolyte which is a molten liquid during operation.

The anode and the cathode for MCFCs are typically porous nickel (Ni) catalysts which are involved in electrochemical reactions for the production of charged ions. The cathode reacts with oxygen supplied from the surrounding air. The anode reacts with hydrogen from a hydrogen-rich fuel supplied to the anode. As a result of the reaction at the anode, anode exhaust fluids, for example water and carbon dioxide, are generated and can be directed away from the anode. Typically, not all of the fuel supplied to the anode is converted into electrical power. Thus some of the unused fuel can travel with the anode exhaust fluids. The unused fuel can be consumed in another reaction which gives off heat. The heat can be used to pre-heat the oxygen and/or fuel supplied to the MCFC.

### SUMMARY OF THE INVENTION

The present invention resides in a fuel cell system having a fuel cell module including a fuel cell stack. The fuel cell stack includes a cathode compartment having a cathode conduit extending from an inlet of the cathode compartment. The cathode conduit conveys a first fluid to one or more cathodes positioned in the cathode compartment. The fuel cell stack also includes an anode compartment having a fuel inlet conduit extending from an inlet of the anode compartment. The inlet conduit supplies fuel to one or more anodes positioned in the anode compartment. The anode compartment has an anode exhaust conduit extending from an outlet thereof, for conveying an anode exhaust fluid out of the anode compartment.

The fuel cell stack is positioned in an enclosure, which has a passage extending therethrough. At least a portion of the passage is in fluid communication with the anode exhaust conduit. The enclosure has diverter means positioned in the passage and/or the anode exhaust conduit. The diverter means is configured to divert the anode exhaust fluid from the anode exhaust conduit to the cathode compartment and/or the passage.

The present invention also resides in a fuel cell module wherein the diverter means includes a plug positioned in the passage for blocking flow of the anode exhaust fluid through the passage and directing the anode exhaust fluid to the cathode compartment.

The present invention also resides in a fuel cell module wherein the anode exhaust conduit includes a first opening defined by an edge. The anode exhaust conduit has an upstream portion positioned upstream of the first opening and a downstream portion positioned downstream of the first opening. The diverter means includes a diverter conduit having a first end and a second end. The first end is positioned in the anode exhaust conduit and spaced apart from the edge such that the diverter conduit and the downstream portion are in fluid communication with one another. The upstream portion is blocked from fluid communication with the downstream portion by an outside surface of the diverter conduit. The diverter means also includes an outer conduit having a mounting end. The mounting end sealingly engages a portion of the anode exhaust conduit adjacent to the edge. The second end of the diverter conduit extends into the outer conduit. There is a diverter outlet flow area located between an inside surface of the outer conduit and the outside surface of the diverter conduit. The diverter outlet flow area is in fluid communication with the upstream portion. The diverter outlet flow area is blocked by a seal positioned between the inside surface and the outside surface. The outer conduit has an outlet opening positioned between the seal and the mounting end.

The present invention also resides in a fuel cell module wherein the diverter device includes a fluid compressor, such as a blower. The fluid compressor has an inlet and an outlet portion. The fluid compressor is used for increasing pressure of the anode exhaust being conveyed through the fluid compressor. The inlet of the fluid compressor is in fluid communication with the anode exhaust conduit and the outlet is in fluid communication with the cathode compartment. In one embodiment, the fluid compressor is driven by driver means, for example, a variable speed drive motor.

### DESCRIPTION OF THE DRAWINGS

FIG. 1 is a schematic of a fuel cell power plant.

FIG. 2 is a flow diagram of the fuel cell power plant of FIG. 1.

FIG. 3 is a schematic view of a portion of a fuel cell module of the fuel cell power plant of FIG. 2

FIG. 4 is a schematic view of the portion of the fuel cell module of FIG. 3 with a passage extending through a cover plate.

FIG. 5 is a flow diagram of the fuel cell power plant connected to a hydrogen recovery system.

FIG. 6 is a cross sectional view of a fluid diverter.

FIG. 7 is a partial cross sectional view of the fluid diverter installed in the fuel cell power plant of FIG. 5.

FIG. 8 is a partial cross sectional view of a fluid compressor installed in the fuel cell power plant.

### DETAILED DESCRIPTION OF THE PREFERRED EMBODIMENTS

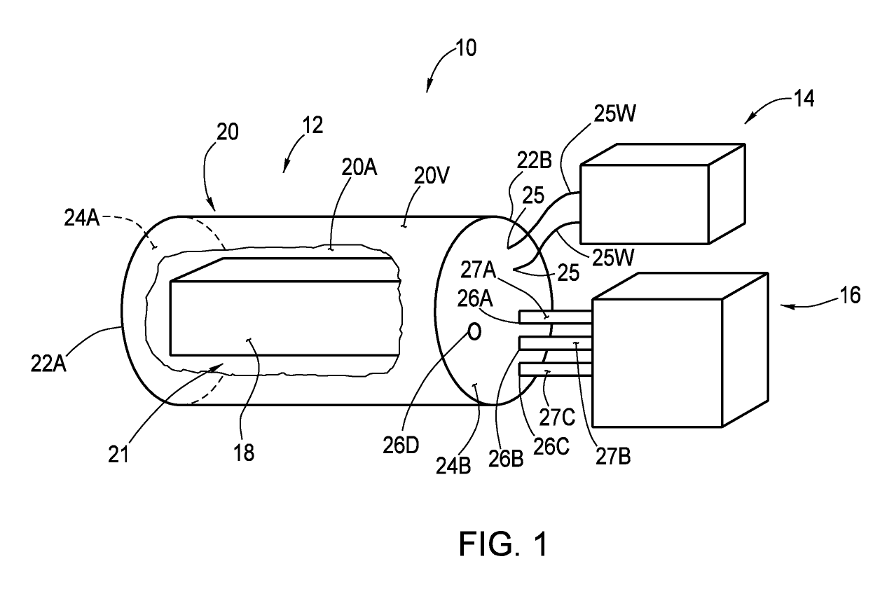

Referring to FIG. 1 a fuel cell power plant 10 is shown having a fuel cell module 12 in electrical communication with an electrical balance of plant module 14. The fuel cell module 12 is shown in fluid communication with a mechanical balance of plant module 16. The fuel cell module 12 has a fuel cell system 18 positioned within an enclosure 20, which is shown with a portion of the enclosure cut away for illustration of the fuel cell system. The enclosure 20 includes a hollow cylindrical vessel 20V illustrated with a portion thereof cut away to show the fuel cell system positioned therein. The vessel 20V has an interior surface 20A defining an opening 21 extending between a first end 22A and a second end 22B of the enclosure. The enclosure 20 includes circular cover plates 24A, 24B removably and sealingly positioned on the first and second ends 22A, 22B, respectively. In one embodiment, the cover plates 24A, 24B and the cylindrical vessel 20V are manufactured from a metal, for example steel.

While the enclosure 20 is described as being a hollow cylindrical vessel 20V and having circular cover plates 24A, 24B, the present invention is not limited in this regard as enclosures and covers of any shape, including but not limited to box shape enclosures and rectilinear covers, can be employed without departing from the broader aspects of the present invention.

The electrical balance of plant module 14 includes electrical equipment (not shown) such as an inverter, power metering, switching equipment and a voltage transformer. The mechanical balance of plant module 16 includes equipment (not shown) needed to feed fuel, air and water to the fuel cell module 12, for preheating and humidifying the fuel and for receiving and treating exhaust fluids from the fuel cell module.

The cover plate 24B is shown having two electrical penetrations 25 extending therethrough. Wiring 25W extends into the fuel cell module 12 through the electrical penetrations. The wiring 25W provides the electrical communication between the fuel cell module 12 and the electrical balance of plant module 14. The cover plate 24B also has first through fourth passages 26A-26D extending therethrough. The first through third passages 26A-26C have respective conduits removably positioned thereon and extending to the mechanical balance of plant module 16, as described below. Use of the fourth passage 26D is described below. Forming the first through fourth passages 26A-26D in the cover plate 24B is a difficult operation that is generally conducted with appropriate machining tools, before installation of the cover plate on the cylindrical vessel 20V.

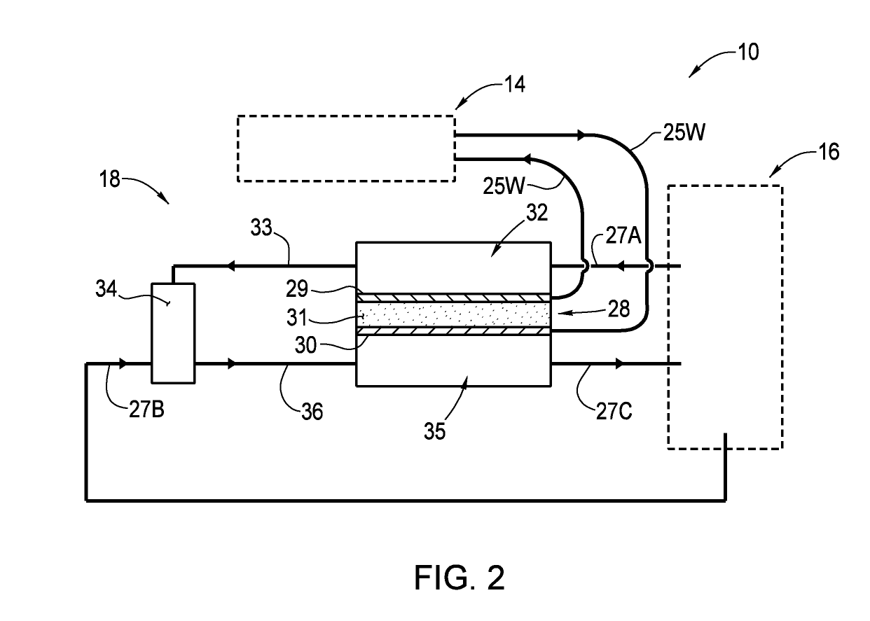

Referring to FIGS. 1 and 2, the fuel cell system 18 is shown, for illustrative purposes, having one Molten Carbonate Fuel Cell (MCFC) 28 which includes an anode 29 and a cathode 30 disposed on opposing sides of an electrolyte matrix 31. The anode 29 is positioned in an anode compartment 32. A fuel inlet conduit 27A extends from the anode compartment 32 to the mechanical balance of plant module 16. The fuel inlet conduit 27A provides fluid communication between the mechanical balance of plant module 16 and the anode compartment 32 for conveying a hydrogen containing fuel into the anode compartment. Because of the operating temperature of the MCFC, the fuel is converted to hydrogen in the anode using waste heat from the fuel cell.

An anode exhaust conduit 33 extends from the anode compartment 32 to a catalytic oxidizer 34. The catalytic oxidizer 34 has a catalyst (not shown) disposed therein. The anode exhaust conduit 33 provides fluid communication between the anode compartment 32 and the catalytic oxidizer 34 for conveying anode exhaust fluids including carbon dioxide, water, residual fuel and/or hydrogen not consumed by the anode 29, to the catalytic oxidizer. An air supply conduit 27B extends from the mechanical balance of plant module 16 to the catalytic oxidizer 34. The air supply conduit 27B provides fluid communication between the mechanical balance of plant module 16 and the catalytic oxidizer 34 for conveying air to the catalytic oxidizer 34.

During operation, the residual fuel, mainly hydrogen and carbon monoxide, in the anode exhaust fluids flow into the catalytic oxidizer 34 and react with oxygen on a catalyst in a chemical reaction which gives off heat. The heat is used to preheat the air which mixes with the anode exhaust fluids within the catalytic oxidizer 34.

The cathode 30 is positioned in a cathode compartment 35. A cathode supply conduit 36 is disposed between the cathode compartment 35 and the catalytic oxidizer 34. The cathode supply conduit 36 provides fluid communication between the cathode compartment 35 and the catalytic oxidizer 34 for conveying preheated air and anode exhaust fluids to the cathode 30 for reaction therewith. A cathode exhaust conduit 27C provides fluid communication between the cathode compartment 35 and the mechanical balance of plant module 16 for conveying cathode exhaust fluids to the mechanical balance of plant module for processing.

While the fuel cell system 18 is shown having one Molten Carbonate Fuel Cell (MCFC) 28 which includes an anode 29 and a cathode 30 disposed on opposing sides of an electrolyte matrix 31, the present invention is not limited in this regard as other configurations including but not limited to, multiple MCFCs configured in any number of stacks, one or more solid oxide fuel cells, one or more phosphoric acid fuel cells and one or more of another type of fuel cell, may be employed without departing from the broader aspects of the present invention.

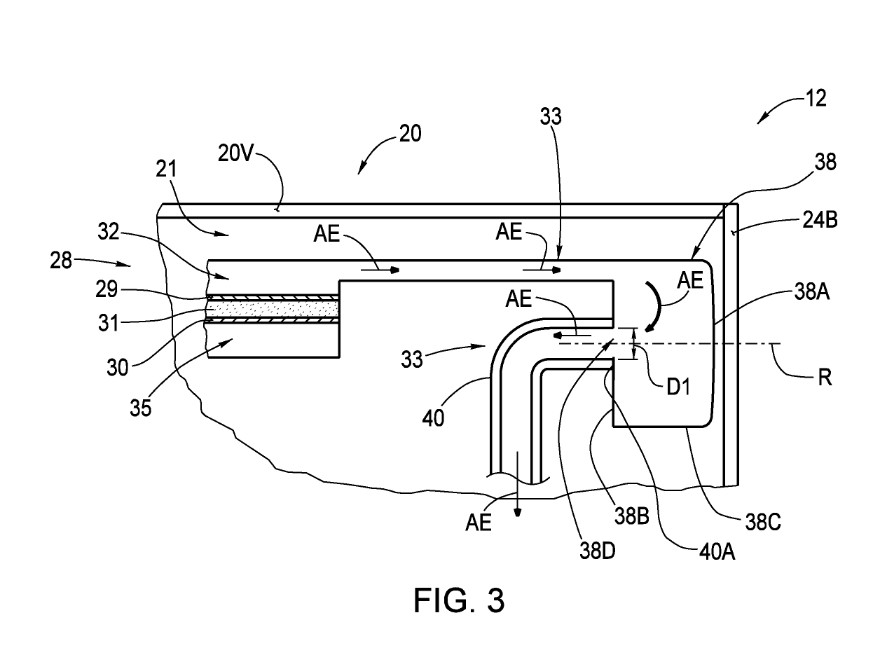

Referring to FIG. 3, the MCFC 28 is shown positioned within the enclosure 20 with the cover plate 24B positioned on the second end 22B prior to modifications needed to allow diversion of the anode exhaust. The anode exhaust conduit 33 extends away from the MCFC 28 and includes a duct portion 38. The duct portion 38 has a first and a second flat portion 38A, 38B positioned parallel to the cover plate 24B and connected to one another by side walls 38C. The second flat portion 38B has a first circular opening 38D defined by a diameter D1. A pipe elbow 40 has a first end 40A secured to the second flat portion 38B. The first circular opening 38D and the first end 40A of the pipe elbow 40 are centered around a reference axis R. The pipe elbow 40 has an inside diameter about equal to the diameter D1 of the first circular opening 38D. The anode exhaust conduit 33, the duct portion 38, and the pipe elbow 40 convey the anode exhaust fluids, designated by arrows AE, to the catalytic oxidizer 34.

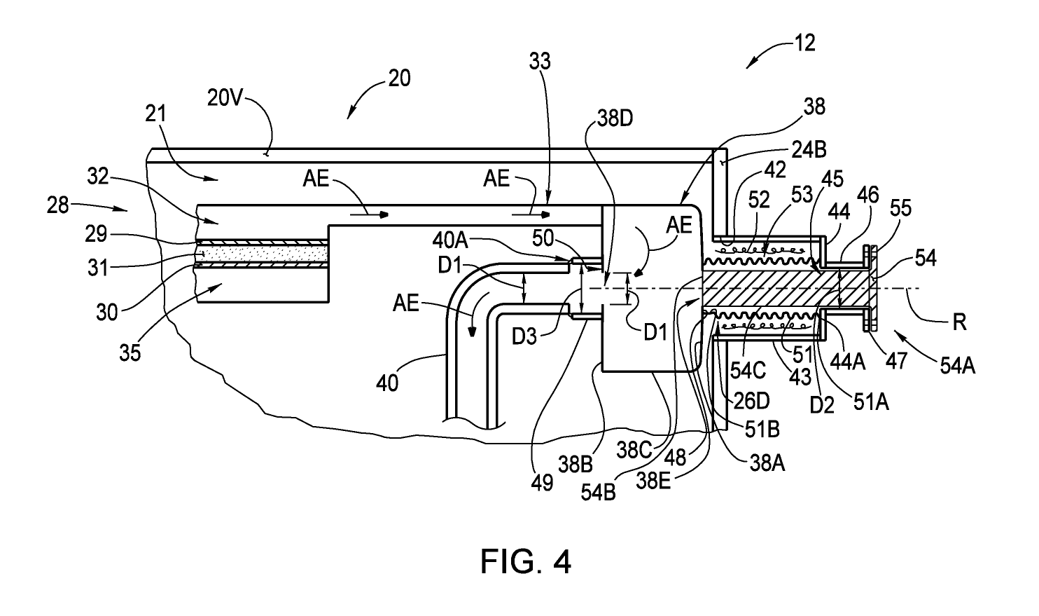

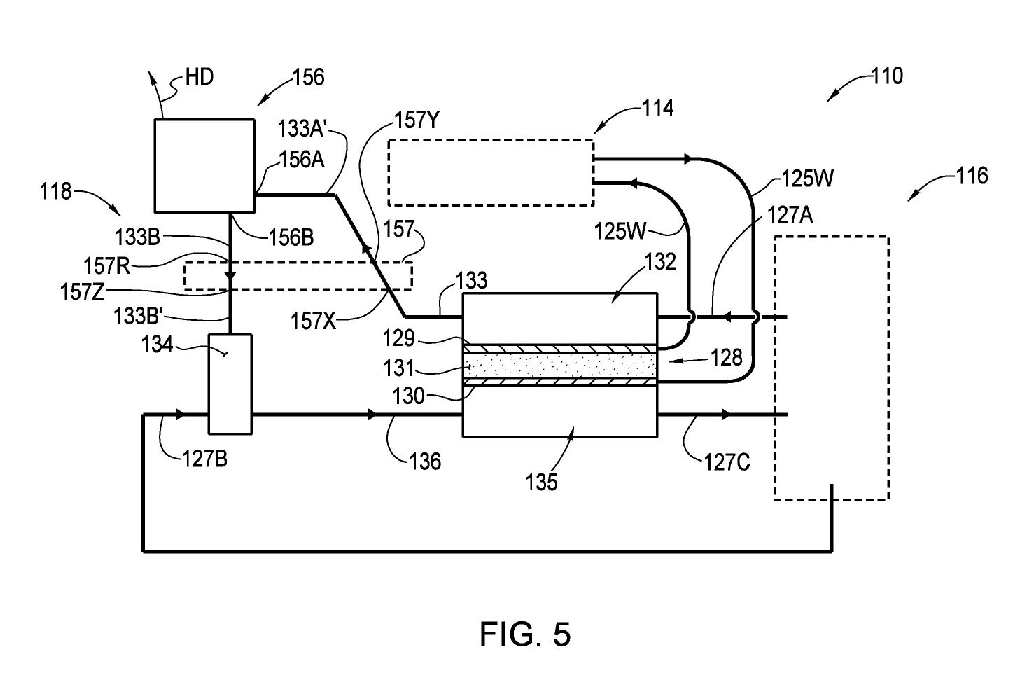

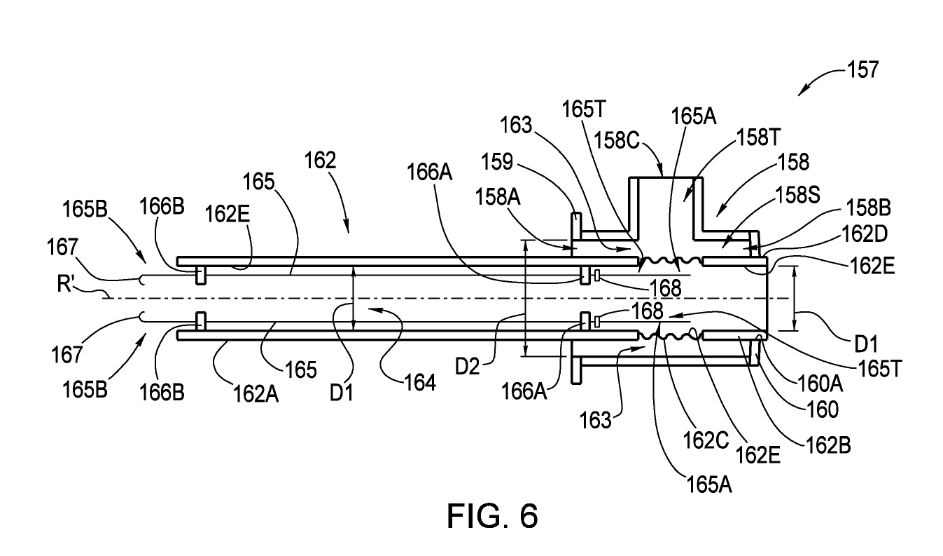

As illustrated in FIG. 4, the fourth passage 26D is added to allow anode exhaust diversion and is positioned in an area of the cover plate 24B which provides access to the duct portion 38. The fourth passage 26D has utility in fuel cells modules, for example, the fourth passage provides options for operation of the fuel cell system 12. One option is to operate the fuel cell system 12 as described with reference to FIG. 2 above. Another option includes operating in a performance enhancing mode in which efficiency of the fuel cell system 12 can be increased. Operation in the performance enhancing mode involves accessing the duct portion 38 through the fourth passage 26D and diverting the anode exhaust fluids from the anode exhaust conduit 33. The anode exhaust fluids exit the fuel cell module 12 through the fourth passage 26D, to an external processing station where hydrogen is recovered from the anode exhaust fluids. The hydrogen lean anode exhaust fluid is returned to the fuel cell module 12 through the fourth passage 26D, after processing in the external processing station. An example of a configuration for implementing such a performance enhancing mode of operation is described below, with reference to FIGS. 5 and 6.

The fourth passage 26D is defined by interior surfaces of an expansion joint 51 and another nipple 46, as described below. The fourth passage 26D penetrates the cover plate 24B in a predetermined position which is located to provide access to the duct portion 38 of the anode exhaust conduit 33. The fourth passage 26D and the cylindrical interior surface thereof are coaxial with the reference axis R. A tubular nipple 43 has one end thereof positioned in the fourth passage 26D and engaged with the cylindrical interior surface 42. A substantially round face plate 44, sized to fit on an opposite end of the tubular nipple 43, is secured to the opposite end of the tubular nipple. The face plate 44 has a second circular opening 45, defined by a diameter D2 which is approximately equal to the diameter of the passage 26D. The other nipple 46 has an inside diameter, about equal to the diameter D2 of the second circular opening 45. One end of the other nipple secured to the face plate 44. The other nipple 46 is positioned coaxially with the reference axis R. A mounting flange 47 extends radially outward from an opposite end of the other nipple 46.

While the tubular nipple 43, round face plate 44, the other nipple 46 and a mounting flange are described, the present invention is not limited in this regard, as other configurations including but not limited to those which utilize members having rectilinear cross sections and those utilizing threaded connections, can also be employed without departing from the broader aspects of the present invention. Although the fourth passage 26D is described as penetrating the cover plate 24B in a predetermined manner to provide access to the duct portion 38, the present invention is not limited in this regard, as other configurations such as but not limited to the fourth passage penetrating any portion of the cover plate 24A, on any portion of the cover plate 24B or on any portion of the cylindrical vessel 20V and/or the fourth passage being positioned to access any portion of the anode exhaust conduit and/or the anode compartment, can be employed without departing from the broader aspects of the present invention.

Referring to FIG. 4, the first flat portion 38A of the duct 38 has a third circular opening 48 defined by a diameter about equal to the diameter D2 of the second circular opening 45 of the face plate 44. The third circular opening 48 is positioned coaxially with the reference axis R. The second flat portion 38B has one end of a spacer ring 49 secured thereto. The spacer ring 49 has an inside diameter D3 of a magnitude greater than the diameter D1 of the first circular opening 38D of the second flat portion 38B. The spacer ring 49 is positioned on the second flat portion 38B coaxially with the reference axis R. An annular-shaped lip 50 positioned on a portion of an outwardly facing surface of the second flat portion 38B, is defined by the inside diameter D1 of the first circular opening 38D and the inside diameter D3 of the spacer ring 49. The lip 50 extends radially inward from the spacer ring. An opposite end of the spacer ring 49 is secured to the first end 40A of the pipe elbow 40. The spacer ring 49 and lip 50 provide an area for securing one or more connectors. The lip 50 can be used for securing connectors when operating in the performance enhancing mode, described below, with reference to FIGS. 5 and 6.

As shown in FIG. 4, the tubular expansion joint 51 having a fluted longitudinal cross section has a first end 51A secured to an inwardly facing portion 44A of the face plate 44 adjacent to the second circular opening 45. A second end 51B of the expansion joint 51 is secured to an outwardly facing portion 38E of the first flat portion 38A adjacent to the third circular opening 48. The expansion joint 51 has an inside diameter about equal to the diameter D2 of the second circular opening 45. The expansion joint 51 contracts and expands as the MCFC 28 heats up and cools down to compensate for differences in thermal growth between the MCFC 28 and the cylindrical vessel 20V and/or the cover plate 24B. Insulation 52 is positioned in an annular space 53 defined by an inside surface of the tubular nipple 43 and an outer surface of the expansion joint 51.

Referring to FIG. 4, a plug 54 having a substantially cylindrically-shaped body has opposing ends 54A, 54B which are closed. One end 54A of the plug 54 has a flange 55 extending outwardly therefrom. The other end 54B of the plug 54 is disposed in the fourth passage 26D coaxially with the reference axis R. Portions of the plug between the opposing ends 54A, 54B are positioned in the expansion joint 51 and in the other nipple 46. The plug 54 is positioned in the expansion joint 51 and the other nipple 46 such that outside surfaces 54C of the plug are spaced apart from respective inside surfaces of the expansion joint and the nipple. The flange 55 is secured to the mounting flange 47, for example by suitable bolting (not shown). A circumferential portion of the opposite end 54B sealingly engages the first flat portion 38A at the third opening 48.

The plug 54 diverts the anode exhaust fluids from exiting the fourth passage 26D. The plug 54 allows for operation of the fuel cell system 12 with the anode exhaust fluid AE being conveyed by the anode exhaust conduit 33, the duct portion 38, the spacer ring 49 and the pipe elbow 40, to the catalytic oxidizer 34. The plug 54 can be removed from the fourth passage 26D and replaced with another device, for example, another diverter when operating in the performance enhancing mode, as described below, with reference to FIGS. 5 and 6.

The fuel cell system of FIG. 5 is similar to that illustrated in FIG. 2, therefore like elements are assigned like numerals, preceded by the number 1. The fuel cell system 118 includes a fluid diverter 157, shown illustratively in dashed lines, for use with a hydrogen recovery system 156 for operating in the performance enhancing mode. The anode compartment 132 has an anode exhaust conduit 133A extending therefrom and to an inlet 157X of the fluid diverter 157. Another section of anode exhaust conduit 133A′ extends from an outlet 157Y of the fluid diverter 157 and to an inlet 156A of the hydrogen recovery system 156. The anode exhaust conduit 133A, a portion of the fluid diverter 157 and the other section of anode exhaust conduit 133A′ is in fluid communication with the inlet of the hydrogen recovery system 156. The anode exhaust fluids, including residual hydrogen not consumed by the anode 129, are conveyed to the hydrogen recovery system 156 through the diverter 157. The hydrogen recovery system 156 extracts the residual hydrogen from the anode exhaust fluids and conveys the recovered hydrogen through a hydrogen discharge conduit HD for subsequent use. Remaining portions of the anode exhaust fluids are conveyed through a return conduit 133B extending from an outlet 156B of the hydrogen recovery system 156 to a return inlet 157R of the fluid diverter 157. Another return conduit 133B′ extends from a return outlet 157Z of the fluid diverter 157 to an inlet of the catalytic oxidizer 134.

While the fuel cell system 112 is described as including the fluid diverter 157 for use with the hydrogen recovery system 156, the present invention is not limited in this regard as the fluid diverter can be used for other purposes, including but not limited to: flowing hydrogen through the outlet 157Y of the fluid diverter 157, from the MCFC 128 anode compartment 132 during an initial conditioning operation of the MCFC 128 when a reducing atmosphere is desired to be maintained on the anode. This hydrogen can then be cooled, slightly compressed with a blower, and then returned to the anode compartment 132 to minimize hydrogen consumption during conditioning and improve the efficiency of the conditioning process.

FIG. 6 illustrates a fluid diverter 157 for use in the fuel cell system of FIG. 5. The fluid diverter 157 includes a pipe tee 158 having a first portion of interior area 158S disposed between an inlet 158A, a first outlet 158B positioned opposite the inlet. The pipe tee includes a branch outlet 158C positioned between the inlet 158A and the first outlet 158B. The pipe tee 158 has a second portion of interior area 158T extending from the branch outlet 158C and extending to the first portion of interior area 158S. The inlet 158A has an inside diameter about equal to the inside diameter D2 of the nipple 46 illustrated in FIG. 4. In addition, the inlet 158A has an outwardly extended flange 159 secured thereto. The first outlet 158B has an inwardly extending flange 160 secured thereto. The inwardly extending flange 160 has an opening defined by a circular edge 160A.

The fluid diverter 157 also includes an internal assembly 162, a portion of which is positioned in the pipe tee 158, as described below. The internal assembly 162 is shown having a first pipe section 162A and a second pipe section 162B, coupled to one another by a tubular expansion joint 162C having a fluted longitudinal cross section. The first and second pipe sections 162A, 162B and the expansion joint 162C are coaxial with a reference axis R′. The circular edge 160A of the inwardly extending flange 160 is sealingly engaged with an outside surface 162D of the second pipe section 162B. An annular flow area 163 is defined by a space between the internal assembly 162 and the pipe tee 158.

The internal assembly 162 further includes two J-bolts 165 each slidingly and rotatably positioned in a pair of tabs 166A, 166B spaced apart from one another and extending inwardly from a portion of an inside surface 162E of the internal assembly corresponding to the first pipe section 162A. The J-bolts 165 are used to removably hold the internal assembly 162 in a predetermined position. A portion of each of the J-bolts 165 has a threaded section 165T initiating at a first end 165A of the J-bolt and terminating at a point on the J-bolt between the tabs 166A, 166B. A second end 165B of the J-bolt 165 has a J-shaped connector 167 secured thereto. Before installation of the fluid diverter 157 into the fourth passage 126D, distal ends of the respective J-shaped connectors 167 are rotated inwardly towards the reference axis R′ so that the J-shaped connectors can pass through the first circular opening 138D. Each of the threaded sections 165T have a nut 168 threaded thereon. The nut 168 and threaded section 165T are used to move the J-bolts 165 relative to the respective tabs 166A, 166B during installation and removal of the fluid diverter 157 to and from the fourth passage 126D.

Although the fluid diverter is described as including a pipe tee 158 and internal assembly 162, the present invention is not limited in this regard as other configurations, such as but not limited to, use of conduits with rectilinear cross sections and one passage with two or more pipes positioned adjacent to one another, can also be employed without departing from the broader aspects of the present invention. While the two J-bolts 165 are described as removably holding the internal assembly 162 in a predetermined position, the present invention is not limited in this regard as more than two J-bolts and other devices for removably holding the internal assembly in the predetermined position, including but not limited to, use of a threaded connection, a bayonet connection and springs can be employed without departing from the broader aspects of the present invention.

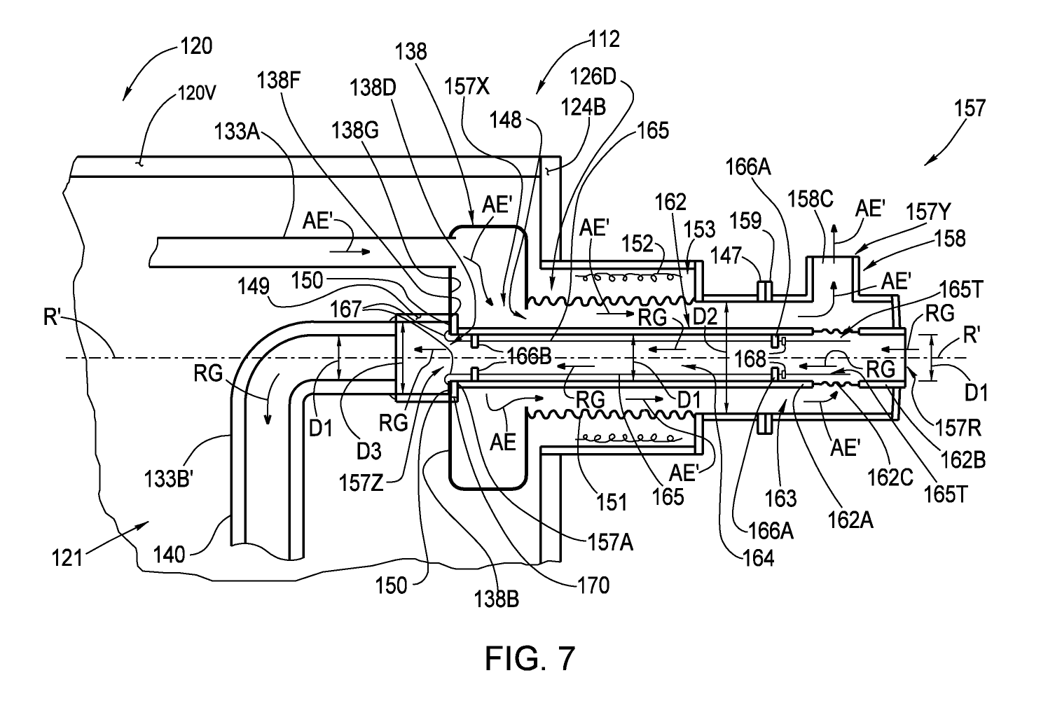

Referring to FIG. 7, the fluid diverter 157 is shown installed in the fuel cell module 112 with the distal ends of the respective J-shaped connectors 167 rotated outwardly from the reference axes R, R′ to engage the lip 150. The flange 159 of the pipe tee 158 portion of the fluid diverter 157 is removably secured to the mounting flange 147. In addition, a gasket 170 is disposed and compressed between one end 157A of the fluid diverter 157 and an annular area 138F adjacent to the first circular opening 138D. The annular area 138F is positioned on an inwardly facing side 138G of the second flat portion 138B. The first pipe section 162A of the internal assembly 162 is removably held in a position by the J-bolts 165 such that the reference axis R′ is coaxial with the reference axis R. The nuts 168 on the respective threaded portions 165T of the J-bolts 165 are screwed along the threaded portions towards the tabs 166A, tensioning the J-bolts and forcing the J-bolt connectors 167 to engage the lip 150. Screwing the nuts 168 on the respective threaded portions 165T causes the gasket 170 to be compressed and creates a seal between the gasket, the one end 157A of the fluid diverter and the annular area 138F.

Referring to FIGS. 5 and 7, during operation, the anode exhaust fluids flow through fuel cell system 118 and the fluid diverter 157 as designated by the arrows AE′. For example, the anode exhaust fluids AE′ exit the anode compartment 132 into the anode exhaust conduit 133A and flow into the duct portion 138. At the inlet 157X of the fluid diverter 157 the first pipe section 162A directs the anode exhaust fluids AE′ into the annular flow area 163. The anode exhaust fluids AE′ then flows through the outlet 157Y of the fluid diverter 157 to the hydrogen recovery system 156. The hydrogen recovery system 156 removes at least a portion of the residual hydrogen from the anode exhaust fluids AE′ thereby creating return fluids RG including carbon dioxide. The return fluids RG flow from the outlet 156B of the hydrogen recovery system 156 through the return conduit 133B into the return inlet 157R of the fluid diverter 157. The return fluids RG flows through the cylindrical-shaped flow area 164, exit through the return outlet 157Z of the fluid conduit 157 and into the other return conduit 133B′ for conveyance to the catalytic oxidizer 134.

Also during operation, the MCFC 128 heats up to a temperature of about 650° C. resulting in a temperature differential between the MCFC and the enclosure 120. As a result of the differential temperature, thermal growth of the MCFC 128, cover plates 124A, 124B and the enclosure 120 differ. During operation, the expansion joints 151, 162C compress to compensate for the difference in thermal growth between the MCFC 128 and the enclosure 120 and/or the cover plates 124A, 124B.

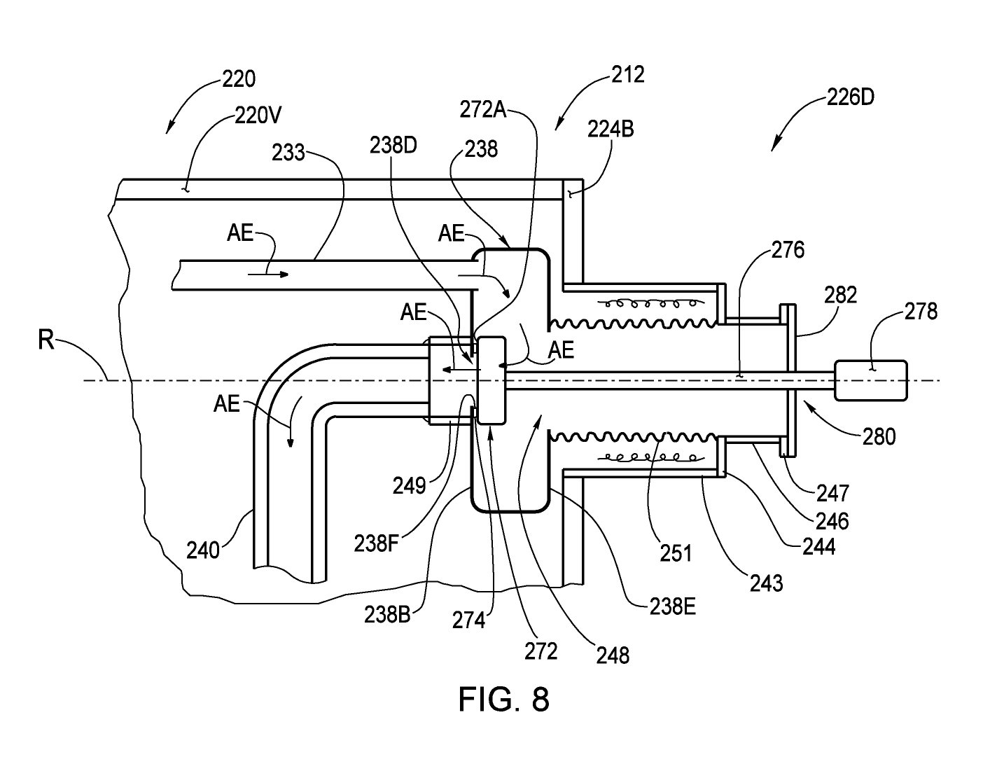

The fuel cell system of FIG. 8 is similar to that illustrated in FIG. 3, therefore like elements are assigned like numerals, preceded by the number 2. Referring to FIG. 8 a pressurizing device 272, for example, a blower is positioned in the duct 238, coaxially with the reference axis R. In addition, a gasket 274 is disposed and compressed between one end 272A of the pressurizing device 272 and the annular area 238F. The pressurizing device 272 is driven by a rotating shaft 276 coupled to a drive unit 278, for example a variable speed drive motor. The shaft 276 extends through a sealed opening 280 extending through a face plate 282 such that the drive unit 278 is positioned outside of the enclosure 220. The face plate 282 is removably secured to the mounting flange 247 by suitable connectors, for example bolting.

During operation, the drive unit 278 operates the pressurizing device 272 to control the differential pressure between the anode compartment 232 and the catalytic oxidizer 234 to minimize the pressure difference between the anode compartment 232 and the cathode compartment 235. This minimizes the leakage of anode gas from the anode inlet to the cathode inlet which minimizes fuel needed and maximizes operating efficiency. This is particularly valuable when effectiveness of the high temperature seal between the anode and cathode has been reduced due to age or other causes. Such pressurizing device may be incorporated after such a reduction is seal effectiveness is observed. The pressurizing device 272 establishes an appropriate magnitude of the differential pressure to maintain the flow of the anode exhaust to compensate for the leakage.

Although the present invention has been disclosed and described with reference to certain embodiments thereof, it should be noted that other variations and modifications may be made, and it is intended that the following claims cover the variations and modifications within the true scope of the invention.

What is claimed is:

1. A fuel cell module comprising:
a fuel cell stack comprising:
a cathode compartment having cathode conduit extending from an inlet of said cathode compartment, said cathode conduit conveying a first fluid to at least one cathode positioned in said cathode compartment; and
an anode compartment having a fuel inlet conduit extending from an inlet of said anode compartment, for supplying fuel to at least one anode positioned in said anode compartment and an anode exhaust conduit extending from an outlet of said anode compartment, for conveying an anode exhaust fluid out of said anode compartment;
an enclosure having said fuel cell stack positioned therein, said enclosure having a passage extending therethrough and wherein at least a portion of said passage is in fluid communication with said anode exhaust conduit; and
diverter means having at least a portion thereof being positioned in at least one of said passage and a said anode exhaust conduit, said diverter means being configured to divert said anode exhaust fluid from said anode exhaust conduit to at least one of a said cathode compartment and said passage.

2. The fuel cell module of claim 1, wherein said diverter means comprises:
a plug positioned in said passage for blocking flow of said anode exhaust fluid through said passage and directing said anode exhaust fluid to said cathode compartment.

3. The fuel cell module of claim 1, wherein:
said anode exhaust conduit has a first opening defined by an edge;
said anode exhaust conduit having an upstream portion positioned upstream of said first opening and a downstream portion positioned downstream of said first opening;
said diverter means comprising:
a diverter conduit having a first end and a second end, said first end being positioned in said anode exhaust conduit and spaced apart from said edge such that said diverter conduit and said downstream portion are in fluid communication with one another and said upstream portion is blocked from fluid communication with said downstream portion by an outside surface of said diverter conduit;
an outer conduit having a mounting end sealingly engaging a portion of said anode exhaust conduit adjacent to said edge and wherein said second end of said diverter conduit extends into said outer conduit;
a diverter outlet flow area between an inside surface of said outer conduit and said outside surface of said diverter conduit, said diverter outlet flow area being in fluid communication with said upstream portion and wherein said diverter outlet flow area is blocked by a seal positioned between said inside surface and said outside surface; and
wherein said outer conduit has an outlet opening positioned between said seal and said mounting end.

4. The fuel cell module of claim 3, wherein said diverter conduit has at least one connector moveably positioned on an inside surface of said diverter conduit and wherein said at least one connector extends into said first opening and engages an outwardly facing lip positioned adjacent to said edge to removably secure said diverter conduit to said anode exhaust conduit.

5. The fuel cell module of claim 4, wherein said at least one connector is a shaft having a threaded portion disposed on one end of said shaft and a J-shaped extension extending from an opposite end of said shaft and wherein a portion of said J-shaped extension extends into said first opening and engages said lip.

6. The fuel cell module of claim 5, wherein said first end of said diverter conduit abuts an annular area adjacent to said edge and wherein said threaded portion has a nut threaded thereon, a surface of said nut movingly engaging a tab extending from said inside surface of said diverter conduit, and wherein said nut transfers a force resulting from rotation of said nut on said threaded portion to said annular area, thereby minimizing thermal expansion effects on said shaft.

7. The fuel cell module of claim 1, wherein said diverter means comprises:
fluid compression means having an inlet and an outlet, said fluid compression means increases pressure of said anode exhaust fluid being conveyed through said fluid compression means, said inlet of said fluid compression means being in fluid communication with said anode exhaust conduit and said outlet of said fluid compression means being in fluid communication with said cathode compartment.

8. The fuel cell module of claim 7
wherein said fluid compression means is driven by driving means.

9. The fuel cell stack of claim 7, wherein said fluid compression means comprises a blower.

10. The fuel cell stack of claim 8, wherein said driver means comprises a variable speed drive motor.

11. A fluid diverter comprising:
a T-shaped conduit comprising a first portion having a first end and a second end and a branch portion positioned between said first end and said second end and wherein said first portion intersects said branch portion;
a second conduit having an outside surface extending between an inlet end and an outlet end of said second conduit, said outlet end being positioned in said first portion of said T-shaped conduit;
an outlet flow area located between an inside surface of said first portion of said T-shaped conduit and said outside surface of said second conduit; and
wherein one end of said outlet flow area is sealed.

12. The fuel cell module of claim 1, wherein:
said anode exhaust conduit is used to recover and recycle hydrogen during the initial conditioning of the fuel cell when a reducing atmosphere is desired at the fuel cell anode side.
